(19) United States
(12) Patent Application Publication
(10) Pub. No.: US 2022/0284746 A1
(43) Pub. Date: Sep. 8, 2022

(54) COLLECTING SENSOR DATA OF VEHICLES

(71) Applicant: Robert Bosch GmbH, Stuttgart (DE)

(72) Inventors: Antonia Reiter, Stuttgart (DE); Indrasen Raghupatruni, Hemmingen (DE); Maria Belen Bescos Del Castillo, Moensheim (DE); Paul Ruhnau, Leonberg-Hoefingen (DE)

(21) Appl. No.: 17/680,909

(22) Filed: Feb. 25, 2022

(30) Foreign Application Priority Data
Mar. 2, 2021 (DE) 10 2021 201 978.1

(51) Int. Cl. G07C 5/08; G07C 5/00; B60W 60/00

(52) U.S. Cl. CPC G07C 5/085; G07C 5/008; B60W 60/0017; B60W 60/00186; B60W 2554/4049

(57) ABSTRACT

A computer-implemented method for collecting sensor data of a vehicle. The method includes receiving of request data that describe at least one data record missing in an existing field data record, in the vehicle. The method furthermore includes a continuous recording of sensor data for the vehicle while the vehicle is in operation and storing recorded sensor data in a short-term memory. The method also includes receiving an acknowledge signal to the effect that certain recorded sensor data correspond to a missing data record, and storing the certain recorded sensor data in a second memory before the recorded sensor data are deleted from the short-term memory.

### BACKGROUND INFORMATION

As repeatedly discussed in the recent past even outside expert groups, the correct and also safe function of vehicles (in particular of at least partly autonomously operating vehicles) can depend decisively on whether the systems of the vehicles are prepared for all relevant driving scenarios (and especially for managing all relevant driving scenarios). The supply of field data (i.e., data collected by vehicles during their operation) is of great importance in this context. If an existing field data record has gaps, then a vehicle configured (e.g., trained) on its basis may possibly be unable to handle driving scenarios in a satisfactory manner. For example, a new vehicle or a new traffic sign may appear at a certain moment in the environment of the vehicle and is therefore not represented in an existing field data record. Errors by the vehicle configured (e.g., trained) on the basis of this field data record may then occur in such a situation. It is therefore desirable to close gaps in the field data record.

### SUMMARY

A first general aspect of the present invention relates to a computer-implemented method for collecting sensor data of a vehicle. In accordance with an example embodiment of the present invention, the method includes receiving request data in the vehicle that describe at least one data record missing in an existing field data record. The method furthermore includes the continuous recording of sensor data for the vehicle while the vehicle is in operation and storing of recorded sensor data in a short-term memory. In addition, the method includes receiving an acknowledge signal to the effect that certain recorded sensor data correspond to a missing data record and storing the certain recorded sensor data in a second memory before the recorded sensor data are deleted from the short-term memory.

A second general aspect of the present invention relates to a device for a vehicle which is designed to check whether recorded sensor data in a short-term memory of a vehicle correspond to a data record missing in an existing field data and storing the recorded sensor data in a second memory if the check reveals that the recorded sensor data correspond to a missing data record.

A third general aspect of the present invention relates to a vehicle which is designed to carry out the steps of the method according to the first general aspect of the present disclosure.

The techniques according to the first to third general aspects of the present invention are able to achieve one or more of the following advantages in some implementations:

For one, gaps in existing field data records are able to be closed. Especially sensor data from a multitude of vehicles (e.g., a fleet of vehicles) may be collected. For example, request data are able to be distributed to the vehicles and processed by the vehicles in order to collect missing data records. This may increase the likelihood that sensor data pertaining to relevant driving scenarios will be collected. These sensor data may in turn contribute to improving the training data records for vehicles (or their systems), which ultimately makes it possible to improve the performance of the vehicles.

In addition, demands on the systems for storing, processing and/or transmitting sensor data are able to be reduced. Considerable data quantities arise per time unit in many vehicles (e.g., data from one or more high-resolution cameras, radar and lidar sensors). The storage and transmission of all or also only a considerable portion of these data may place extreme demands on the processing systems (and for technical reasons, may be utterly impossible in some situations). In certain cases, the storing of large quantities of data (and especially by a larger fleet of vehicles) may also be inappropriate (for regulatory reasons, for instance).

Moreover, a considerable portion of the recorded sensor data may relate to driving scenarios that are already appropriately represented in an existing field data record and will therefore not make a significant contribution to an improvement of the vehicles (or their systems). Since the techniques of the present invention trigger the storing of sensor data (only) if a missing data record is identified in the existing field data record, the demands on the systems for storing, processing and/or transmitting sensor data can be lower (and drastically lower in some instances). Instead of a steady stream of sensor data, the storage and/or transmission of sensor data may take place only intermittently. This may in turn reduce the complexity and/or cost of the systems used for collecting the field data and in some instances may even allow the collection of field data in the first place.

Thirdly, the collection of sensor data can be triggered or carried out automatically in some cases (that is to say, without the intervention of a user of the vehicle). This, too, makes it possible to efficiently close gaps in an existing field data record in some cases.

Certain terms in the present disclosure are used in the following way:

The term ‘vehicle’ encompasses any device that transports passengers and/or freight. A vehicle may be a motor vehicle (such as a passenger car or truck) but also a rail vehicle. Even floating and flying devices may be vehicles.

The term ‘at least partly autonomously operating vehicle’ therefore includes all devices that transport passengers and/or freight in an at least partly autonomous manner. An at least partly autonomously operating vehicle may be a motor vehicle (such as a passenger car or a truck), but also a rail vehicle. The attribute ‘at least partly autonomous’ expresses that the vehicle is controlled autonomously (that is to say, without the participation of a user) in at least some situations and/or at least at certain times, and/or that certain systems of the vehicle (such as assistance systems) assist the driver at least intermittently (e.g., an emergency braking system or a lane-keeping assistant). In the present disclosure, assisted driving is encompassed by the term ‘at least partly autonomously operating’. More specifically, the present disclosure relates to at least partly autonomous motor vehicles, which is why aspects of the disclosure in the following text are described using examples of at least partly autonomously operating motor vehicles (e.g., autonomous vehicles of the autonomy levels 4 or 5). However, the corresponding aspects are also transferrable to other types of vehicles (provided they do not pertain to specific conditions of at least partly autonomously operating motor vehicles).

The term ‘user’ includes any person driving with the vehicle, being transported by this vehicle or monitoring its operation. A user may be a passenger of a vehicle (in particular a driver). However, a user may also be located outside the vehicle and control and/or monitor the vehicle (e.g., during a parking operation or from a remote central control center).

An ‘operating scenario’ may be any scenario that arises during the operation of the vehicle. For instance, an operating scenario may be a certain driving situation. An operating scenario could relate to a time-limited segment during the operation of the vehicle (e.g., shorter than 10 minutes or shorter than one minute). Operating scenarios are not restricted to scenarios in which the vehicle is moving (i.e., driving). Additional examples of operating scenarios can be found below.

The term ‘request data’ denotes data that describe at least one data record missing in an existing field data record (in the delimitation from other data addressed in the present disclosure).

The term ‘sensor data’ includes all data acquired for the vehicle during the operation of the vehicle. The sensor data are able to be acquired by sensors of the vehicle. Sensor data may additionally also be acquired outside the vehicle (and transmitted to the vehicle). GPS data (or other position data) are sensor data, for example. The term ‘sensor data’ also includes processing stages of the data recorded by the respective sensors and corresponding metadata. Additional examples can be found further below.

‘Field data’ include all data that arise in connection with the operation of a vehicle (or a multitude of vehicles) and which are used especially for configuring (e.g., training) vehicles (or their systems). For instance, field data may be used to generate corresponding operating scenarios in a simulation environment for training vehicles (or their systems). A ‘field data record’ is a body of field data. In some instances, the field data record may include the field data in a form structured according to a single predefined scheme. However, the field data record may also be made up of different partial data records which are structed in a different way in each case.

### BRIEF DESCRIPTION OF THE DRAWINGS

FIG. 1 is a flow diagram illustrating a method in accordance with an example embodiment of the present invention.

FIG. 2 schematically shows components of a system for collecting and evaluating sensor data of a vehicle, in accordance with an example embodiment of the present invention.

### DETAILED DESCRIPTION OF EXAMPLE EMBODIMENTS

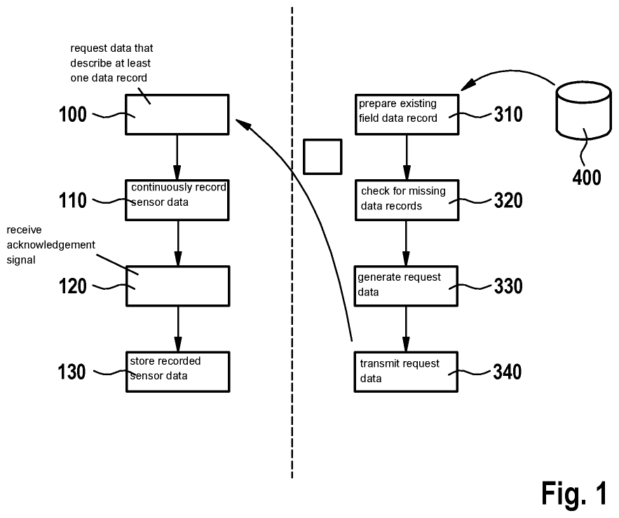

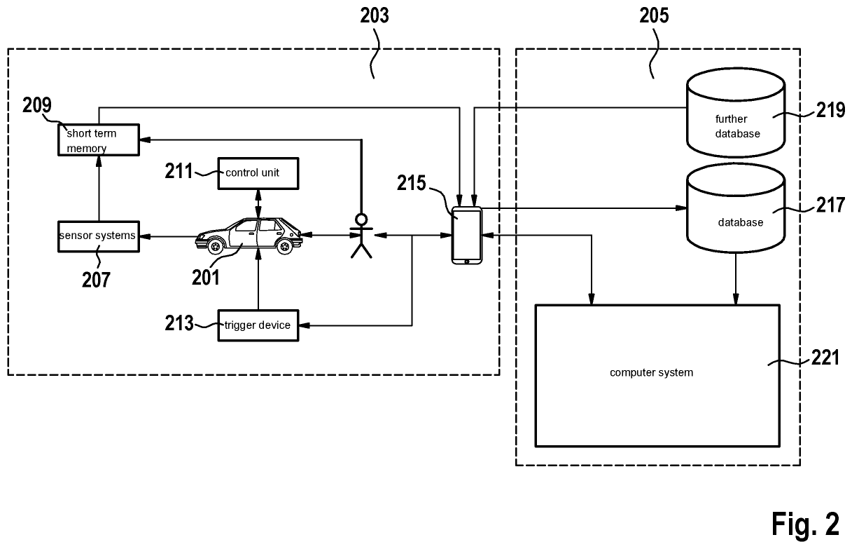

At the outset, the sequence of the method for collecting sensor data of the present invention will be described with reference to FIG. 1. Aspects of the systems in which the methods for collecting of sensor data of the present disclosure are able to be carried will then be illustrated in greater detail with reference to FIG. 2.

FIG. 1 is a flow diagram illustrating the methods of the present invention. A distinction is made in FIG. 1 between steps that take place inside a vehicle (left column) and those that are carried out at a distant location (right column). The division of the tasks serves only as an example.

In a step 100, request data that describe at least one data record missing in an existing field data record are received in the vehicle. For example, request data may be transmitted to the vehicle (and received therefrom) at certain intervals or triggered by certain events. For example, the request data may describe a certain operating scenario (or a multitude of certain operating scenarios). An operating scenario may correspond to a certain driving maneuver and/or a certain operating situation and/or a certain driving route. The travel of a certain segment of a driving route, for example, (e.g., a road or traffic lane) may be an operating scenario. In addition or as an alternative, the execution of a certain driving maneuver could be an operating scenario (e.g., a braking operation, a passing maneuver, a parking operation, etc.). An operating scenario furthermore may additionally or alternatively be a certain operating situation (e.g., certain light or weather conditions, a dangerous situation, or an accident situation, encountering certain other road users or objects in the environment of the vehicle and/or the occurrence of defects or an abnormal behavior of the vehicle, other road users and/or objects in the environment).

In one illustrative example, the request data may describe that sensor data for driving under foggy conditions on a certain route section is missing in a field data record. In a different (or an additional) example, the request data may describe the appearance of certain objects in the environment of the vehicle.

The request data may have any format suitable for describing missing data records (or associated operating scenarios) in an existing field data record. For example, a missing data record (or an associated operating scenario) may be described based on status information of the vehicle and/or its environment (which once again may be sensor data according to the present disclosure).

In the illustrative example, location data describing the particular route segment and visual range data could be defined in order to describe the aforementioned operating scenario. In other examples, the request data may include sensor data that can be used to detect the missing data record (or an associated operating scenario). For instance, one or more image(s) of a certain (new) object that is moving or present in the operating environment of the vehicle may be included by the request data.

If the request data are at least addressed also to the user of the vehicle, then they may include user-readable information (e.g., text and/or image data). If the request data are at least able to be processed also in the vehicle in an automated manner, then they may include machine-readable information.

In some examples, information about the received request data can be supplied to a user, in particular a passenger of the vehicle (e.g., via a user interface of the vehicle or a mobile device).

In addition, sensor data for the vehicle are continuously recorded while the vehicle is in operation and then stored in a short-term memory 110. The sensor data, for instance, may be present in the form of time series data. For example, the sensor data can include camera data (e.g., in the visible or infrared spectral range), lidar sensor data, radar sensor data, temperature sensor data and/or ultrasound sensor data. Alternatively or additionally, the sensor data may describe position data (such as GPS data), for instance, or vehicle data describing an operating state of the vehicle (e.g., steering angle, rotational speed, operating mode, loading, etc.). The sensor data are able to characterize the environment of the vehicle, its interior and/or its operating status. It is possible that the corresponding sensors generating the sensor data are part of the vehicle. In other cases, however, the sensors may also be located outside the vehicle (e.g., in infrastructure components or in other vehicles or road users).

In one illustrative example, the sensor data may be camera data from a camera of a motor vehicle (e.g., of a camera pointing in the driving direction). These camera data are continuously processed (for instance to set up an environment model of the vehicle) and deleted again from (or overwritten in) the short-term memory after being processed. The same applies to other sensor data that are likewise retained in the short-term memory only for a certain period of time.

In addition, an acknowledge signal 120 to the effect that certain recorded sensor data correspond to a missing data record is received in the vehicle. The generation of the acknowledge signal may be undertaken automatically or by the user (or in a mixed form).

If the acknowledge signal is generated automatically (or at least partly automatically), then the method may include a check whether certain recorded sensor data correspond to the missing data record based on the received request data, and the generation of the acknowledge signal in the event that the check reveals that the certain recorded sensor data correspond to the missing data record.

For example, the check may include an automatic comparison of the request data with the recorded sensor data. As described earlier, the request data may assume any form that makes it possible to identify sensor data for a missing data record (e.g., for a certain operating scenario). For that reason, the step of checking may also be carried out in different ways. It is merely required that it can be determined that sensor data corresponding to the missing data record (e.g., that a certain operating scenario has occurred) have been recorded for the vehicle at a certain moment.

For example, within the framework of the check it is possible to determine whether the sensor data have assumed certain values specified in the request data. This check may also be carried out based on processing stages of the sensor data (e.g., using an environment model). In other examples or in addition, it may be checked whether the environment and/or the vehicle is/are in a certain static or dynamic state specified in the request data. This check can also be carried out based on processing states of the sensor data (e.g., using an environment model). In other examples or in addition, it may be checked whether the environment and/or the vehicle is/are in a certain static or dynamic state specified by the request data (e.g., whether a certain weather or visual range situation is present, whether a vehicle is moving along a certain trajectory or whether certain objects are located in an environment of the vehicle). As previously described, the check is able to be carried out inside the vehicle.

In the illustrative example introduced in the above text, a check may include a comparison of the position data of the vehicle with the position data of the route segment described in the request data. Moreover, the presence of foggy weather conditions is able to be determined by evaluating a camera image or metadata.

The afore-described checks may be carried out continuously during the operation of the vehicle (e.g., at predefined time intervals). In other cases, the check may be triggered by one or more event(s) (for instance by an error report or by a user of the vehicle).

Additionally or alternatively, the recorded sensor data are able to be checked for a plurality of data records (e.g., operating scenarios of the vehicle) described in the request data and missing in the field data record. A check need not take place in real time. However, it may be necessary for a check to be concluded at a certain point in time after the recording of the sensor data (e.g., no later than a minute after the sensor data were recorded) because in some instances the sensor data (to be transmitted) are possibly no longer available (that is to say, were deleted from the short-term memory or overwritten in the short-term memory).

In some examples, a user of the vehicle is able to generate the acknowledge signal (based on the supplied request data).

The user may be made aware of information from the request data (e.g., via a corresponding message that informs the user via a mobile device 215 or a user interface of the vehicle). In some examples, information pertaining to the missing data record is able to be conveyed to the user. For example, a brief text and/or visual description of the missing data record (e.g., the operating situation) may be provided. The text and/or visual description could be included in the request data or be generated therefrom. The user is then able to operate an input interface of the vehicle or the mobile device in order to generate the acknowledge signal. The input interface can be a key or some other haptic interface (e.g., as part of a contact-sensitive user interface) or a voice interface.

For example, the request data may describe that sensor data pertaining to the encountering of a certain vehicle are missing in the field data record. When the user encounters the particular vehicle during its operation, the user is able to generate the acknowledge signal via an interface of the vehicle. The respective recorded sensor data are then stored 130 in a second memory after the acknowledge signal (either generated by a device or a user) is received before the recorded sensor data are deleted from the short-term memory.

In some examples, the storing may take place if the comparison reveals that certain recorded sensor data correspond to a missing data record, especially for a certain operating scenario. The generation of the acknowledge signal in some cases may include the transmittal of a request to acknowledge an acknowledge signal to a user, in particular a passenger in the vehicle. A notification of this request can be made via a user interface of the vehicle (e.g., as visual, audible or audio-visual information). This request may be displayed to the user on a graphical user interface (e.g., ‘object X detected!’) and/or with the aid of a head-up display of the vehicle, for instance. As an alternative or in addition, the user is able to be notified of the request with the aid of a mobile device (e.g., via a mobile telephone) situated in the vehicle (and networked therewith). Further aspects of the system environment will be described in the following text. The user is then able to acknowledge the acknowledge signal by inputting an appropriate control command.

In some examples, further information pertaining to the missing data record is able to be provided to the user. A brief text and/or visual description of the missing data record (e.g., the operating situation) may be given, for example. This text and/or visual description can be included in the request data or be generated therefrom. In one illustrative example, the description may read: ‘Object X encountered!’. The conveying of information may allow the user to check whether the current sensor data do indeed correspond to a missing data record (for instance so that erroneously classified sensor data are able to be discarded). In other cases—as described above—information regarding the missing data record from the request data may be conveyed to the user for a check whether the recorded sensor data correspond to a missing data record.

The storing may be performed in different ways. In some examples, the storing may take place automatically. In other examples, the stored sensor data may be transmitted (e.g., to a remote system). For instance, a device situated in the vehicle (more details will follow) is able to transmit the recorded sensor data.

Metainformation in connection with sensor data are additionally able to be requested from the user in some examples. To this end, the user may be asked to input the metainformation via a suitable interface. The received metainformation are also transmittable from the direction of the vehicle. In some examples, the metainformation may include labels for recorded sensor data (e.g., labels describing the content of the recorded sensor data which may later be used while training a machine learning system, as the case may be).

In the latter paragraphs, the techniques of the present disclosure were described based on a single vehicle. The techniques of the present disclosure are carried out using multiple vehicles in some examples (e.g., a fleet of 100 or more or 1000 or more). For instance, request data can be sent to multiple vehicles. In addition or as an alternative, sensor data from multiple vehicles are able to be stored (and further processed). The sensor data from the multiple vehicles can be jointly used for closing gaps in field data (that is to say, be fused into its data record).

In these examples, the same request data are able to be made available to multiple vehicles. In other examples, at least partly different request data can be made available to different vehicles of the multiple vehicles. The different request data may be randomly distributed or distributed according to a predefined pattern (e.g., under consideration of available information about the individual vehicles such as typical driving routes, vehicle type and so on).

In some examples, it is possible to provide feedback to a user (e.g., a passenger) of the vehicle with regard to his or her contributions to the supply of sensor data for data records missing in a field data record (e.g., via an interface of the vehicle or via a mobile device). The feedback may have an encouraging content (to motivate the user to transmit further sensor data) and/or may include statistical data in connection with the contributions of the user to the supply of sensor data in connection with data records missing in a field data record (e.g., how often the user has triggered a transmission of sensor data, data for comparing an activity of the user with other users, or similar data).

In the following paragraphs, aspects of the generation of the request data and the processing of the transmitted sensor data will be described in greater detail.

The generation of the request data may include one or more of the following steps, which may be carried out by a computer system located at a distance from the vehicles or vehicles (see FIG. 1, right column).

An existing field data record is able to be stored in a database 400 (here, the term ‘database’ also includes situations where the field data record is made up of different partial data records that are stored at different locations and/or stored using different schemata).

The field data record may include field data collected by vehicles in the past (and in some instances also data from simulators and/or synthetic field data).

The existing field data record may first be prepared 310 by suitable steps (e.g., using a system trained by machine learning).

The existing field data record can be checked 320 for missing data records (also referred to as ‘gaps’ in this disclosure). As described earlier, such missing data records may relate to driving scenarios of a vehicle. A missing data record can pertain to a driving scenario not yet imaged in the existing field data record. In other cases, a missing data record may be a data record that already exists but not yet in a desired number and/or a desired quality (e.g., the record has gaps and/or the data appear to be faulty).

The check of the existing field data record is able to be performed in an automated or partly automated manner (e.g., with the aid of a system trained by machine learning).

In a further step, request data are able to be generated 330 (the content and the structure of the request data were described above) based on the detected missing data records. For instance, it may result that data records for certain operating scenarios (such as for certain route segments and/or for certain driving maneuvers and/or certain environment situations) are missing in the existing field data record. The request data will then be generated in such a way that a comparison with currently recorded sensor data is able to be carried out during the operation of the vehicle (that is to say, computationally intense steps are performed while the request data is generated so that a check is able to be performed in the vehicle with limited resources and/or an available time and/or by the user).

The request data are finally transmitted 340 to a vehicle or multiple vehicles (via a suitable network link). The transmittal may take place repeatedly (e.g., as soon as new request data are available).

In some examples, the afore-described steps are able to be repeated after a certain period of time or after certain events have occurred (e.g., an update of the existing field data record).

As may be gathered from FIG. 1, the processes of generating the request data are able to be performed on systems located at a distance from the vehicle or vehicles. In some instances, the generation of the request data or sub-steps of the generation of the request data may also be carried out in the vehicle itself.

As described earlier, the vehicle or vehicles store(s) (and possibly transmit(s)) sensor data (continuously or at certain intervals) if it has been detected that they correspond to a missing data record described in the request data. These sensor data are able to be updated in the existing field data record (in some examples after one or more processing step(s)). This makes it possible to close gaps in the field data record.

The present disclosure also relates to the use of a field data record augmented by the techniques described in this document.

For example, a training data record for a machine learning system (e.g., an image classifier) is able to be generated for a vehicle with the aid of the stored recorded sensor data/the augmented field data record. The present disclosure also includes training of a machine learning system of a vehicle utilizing the stored recorded sensor data/the augmented field data record.

In other examples, a vehicle or a module or system of a vehicle is able to be tested or validated with the aid of the stored recorded sensor data and/or the augmented field data record.

Additionally or alternatively, the stored recorded sensor data and/or the augmented field data record may be used to generate a simulation environment (e.g., for the CARLA simulator). Systems or modules for a vehicle may then again be trained, validated and/or tested in the simulation environment.

In the previous paragraphs, the methods for collecting sensor data of a vehicle were described in great detail with the aid of

FIG. 1. FIG. 2 schematically shows components of the system for collecting and evaluating sensor data of a vehicle of the present disclosure.

In FIG. 2, components that are (at least intermittently) located inside a vehicle 201 (‘inside’ in this connection denoting all components that move by and with the vehicle) are enclosed by a first box 203. The car symbol is merely used for illustrative purposes. In a second box 205, systems are shown that are situated at a remote location from the vehicle and execute the afore-described steps of augmenting the field data record and/or generating the request data.

Vehicle 201 may include one or more sensor system(s) 207. In other examples (or in addition), the vehicle may be coupled with sensor systems (e.g., sensor data from other vehicles or road users or sensor systems of infrastructure components) for the purpose of recording sensor data. Sensor systems 207 (inside our outside vehicle 201) may include one or more of the following: a camera system (e.g., for the visible or infrared spectral range and/or for monitoring an environment of the vehicle or the interior of the vehicle), a radar system, a lidar system, an ultrasonic sensor system, a system for ascertaining or acquiring position data (e.g., GPS data), one or more temperature sensors, a system for ascertaining dynamic vehicle states (for instance including acceleration sensors and/or position sensors) and/or further sensors.

In some cases, the sensor data are able to be recorded as time series (with fixed or dynamic sampling instants).

The sensor data of these sensor systems 207 may be recorded in vehicle 201 and stored in a short-term memory 209. As described in the previous text, sensor data may be processed. In one example, short-term memory 209 is configured in such a way that the sensor data are stored only for a certain period of time and then deleted or overwritten (e.g., after less than five minutes or less than one minute). The time period may be constant or variable. In one example, short-term memory 209 is a ring buffer. The ring buffer is able to be filled with new sensor data on a continuous basis, and when a new datum is fed in, an older datum drops out of the ring buffer. In this way, the sensor data are available for a certain period of time for the described check step for ascertaining whether the recorded sensor data correspond to a missing data record based on the received request data.

In FIG. 2, the second memory is a part of mobile device 215 situated in the vehicle. In other cases, the second memory may also have a different development. For example, the second memory could be situated in the vehicle or also outside the vehicle. The second memory can be a persistent memory (e.g., a FLASH memory or some other memory), e.g., in order to store the recorded sensor data for a longer period (‘a longer period’ in this case may mean until the sensor data stored in the second memory are read out, e.g., more than 5 minutes or more than two hours). In other cases, however, a set of sensor data may also be stored for a further time period in another memory following a pre-check step (and, for instance, the detection of a potential relevance of the set of sensor data). In some examples, it is possible to provide a memory device that stores all or a plurality of the sensor data also for a further time period. However, such a procedure is not practicable in many situations on account of the huge data quantity produced by sensor systems 207. For this reason, it may be useful in many situations to carry out the described check step for a determination whether the recorded sensor data correspond to a missing data record based on the received request data, in real time (that is to say, less than one minute after the corresponding sensor data were recorded). The demands on the system resources of vehicle 201 are able to be reduced in this way.

The incorporation of the sensor data in short-term memory 209 is able to be controlled by a control unit 211 of vehicle 201.

Request data are also received in vehicle 201 (aspects of the request data have been described earlier in connection with FIG. 1). This may be realized via different channels.

The request data may be received via an air interface (e.g., via a mobile radio channel or via a wireless LAN channel). In some examples, the request data are able to be received via a mobile device 215 located in the vehicle. In the example of FIG. 2, mobile device 215 is a smartphone. In other examples, mobile device 215 can be a laptop, a tablet, or a module of another portable device situated in the vehicle. Mobile device 215 is able to be coupled with an internal communications network of vehicle 201 (e.g., a wireless or wire-conducted LAN, which uses a WiFi or Bluetooth communications protocol, for example). In this way, a mobile device 215 situated in the vehicle can be used as an interface for vehicle 201 for receiving the request data. In addition to the communications channels provided by mobile device 215 (e.g., a mobile radio channel), further functions of mobile device 215 can also be used in the communications process of the request data (e.g., authentication and encryption functions).

Mobile device 215 may be equipped with a dedicated software (such as an application software) for carrying out the receiving and forwarding of request data. In some examples, as described above, the request data are able to be brought to the user's attention via an interface of mobile device 215 (e.g., via a graphical user interface of mobile device 215).

In other examples (or additionally), the request data are able to be received via a communications interface (not shown in FIG. 2) permanently installed in vehicle 201.

In other examples (or additionally), the request data are able to be output to the user (such as via a screen, a head-up display and/or an audio output device) via a user interface permanently installed in vehicle 201 (not shown in FIG. 2).

The received request data are able to be stored in a memory of the vehicle (not shown in FIG. 2).

In addition, the vehicle may include a trigger device 213. Trigger device 213 can be configured to generate the acknowledge signal. In some examples, trigger device 213 is able to check whether recorded sensor data in a short-term memory 209 of vehicle 201 correspond to a data record missing in an existing field data record. On the one hand, trigger device 213 may access the received request data for this purpose, and on the other hand, i may access the recorded sensor data in short-term memory 209. Trigger device 213 may be configured to carry out the aspects of the check described in greater detail in the previous text.

In some examples, trigger device 213 is furthermore configured to trigger the storing of recorded sensor data in the second memory if the check reveals that the recorded sensor data correspond to a missing data record. This may be undertaken in different ways, as described earlier in the text.

In some examples, the sensor data are transmitted from the second memory (e.g., to a remote computer system). In some examples, the transmission is automatically triggered if the check by trigger device 213 reveals that the recorded sensor data correspond to a missing data record. In other examples, the triggering of the transmission may include a contribution of the user. For instance, via mobile device 215 and/or a user interface of the vehicle (not shown in FIG. 2), the user may be notified that the recorded sensor data correspond to a missing data record. The user is then able to initiate the transmission of the sensor data (or refrain from doing so).

Trigger device 213 may be a dedicated hardware and/or software component or be integrated into another system of vehicle 201.

The recorded sensor data may once again be transmitted via a communications interface permanently installed in vehicle 201 or via mobile device 215 located in the vehicle (using the communications channel previously described in connection with the receiving of the request data).

In other examples, the user is notified of the request data via mobile device 215 and/or a user interface of the vehicle (not shown in FIG. 2). In this case, the user is able to carry out the check for ascertaining whether the recorded sensor data correspond to a missing data record. Vehicle 201 may then be configured to receive the acknowledge signal of the user for storing the recorded sensor data in the second memory (for instance via mobile device 215 or a user interface of the vehicle such as a button, a lever, or a voice-controlled interface).

The transmitting of the sensor data from the second memory may take place immediately in some instances (e.g., as soon as a suitable communications channel is available). In other examples, the sensor data are able to be stored in vehicle 201 in the second memory for a certain period of time. In some examples, the sensor data stored in the second memory are able to be read out via a certain interface (e.g., a wire-conducted or an air interface). This may occur when the vehicle is parked in a certain environment, for instance.

Moreover, FIG. 2 schematically shows a database 217 which includes the existing field data record (here, the term ‘database’ also includes situations in which the field data record is made up of different partial data records that are stored in different locations and/or in different schemata). For example, the existing field data record may be stored in a Cloud memory. This database 217 stores the sensor data transmitted from vehicle 201 (e.g., via mobile device 215). This may include one or more processing step(s) in order to bring the sensor data into a suitable format for storing in database 217. The sensor data may also be buffer-stored. In some cases, the transmitting of the sensor data originates in vehicle 201 (as a push communication). In other cases, the transmitting of sensor data may be requested from the vehicle.

Database 217 is able to be coupled with a computer system 221 in which the described steps of checking which data records are missing in the field data record and/or the generating of the request data are carried out.

The system may include a further database 219 in which the afore-described feedback is provided that pertains to contributions of a user to the supply of sensor data in connection with data records missing in a field data record. This feedback can once again be received with the aid of mobile device 215 or a communications interface of vehicle 201 and be brought to the attention of the user via mobile device 215 and/or a user interface of the vehicle.

The components and systems described in this disclosure may include any hardware and/or software suitable for realizing the described functions. The respective components and systems may include dedicated devices (having corresponding processors, memories, interfaces, and other elements) or may be integrated into a further system.

The present disclosure also relates to computer programs able to carry out the methods of this disclosure. In addition, this disclosure also relates to computer-readable media or signals that store or include the computer programs of the present disclosure.

In addition, this disclosure pertains to machine-readable signals that include request data according to the present disclosure.

1-15. (canceled)

16. A computer-implemented method for collecting sensor data of a vehicle, comprising the following steps:
receiving, in the vehicle, request data that describe at least one data record missing in an existing field data record;
continuously recording sensor data for the vehicle during operation of the vehicle and storing recorded sensor data in a short-term memory;
receiving an acknowledge signal indicating that certain of the recorded sensor data corresponds to a missing data record; and
storing the certain recorded sensor data in a second memory after receiving the acknowledge signal before the recorded sensor data are deleted from the short-term memory.

17. The method as recited in claim 16, wherein each missing data record belongs to a certain operating scenario, the certain operating scenario including a certain driving maneuver and/or a certain operating situation and/or a certain driving route and/or encountering certain other road users or objects in an environment of the vehicle.

18. The method as recited in claim 16, further comprising:
checking whether the certain recorded sensor data correspond to the missing data record based on the received request data,
generating the acknowledge signal when the check reveals that the certain recorded sensor data correspond to the missing data record;
wherein the checking includes an automatic comparison of the request data with the recorded sensor data.

19. The method as recited in claim 16, further comprising:
transmitting the sensor data stored in the second memory, the sensor data stored in the second memory being transmitted via a communications interface permanently installed in the vehicle or via a mobile device situated in the vehicle.

20. The method as recited in claim 16, wherein the request data are received via a communications interface permanently installed in the vehicle or a mobile device situated in the vehicle.

21. The method as recited in claim 16, wherein the acknowledge signal is generated by a device in the vehicle or is received via a user interface of the vehicle or a mobile device located in the vehicle.

22. The method as recited in claim 16, wherein the storing in the second memory includes automatic storing or a user-initiated storing.

23. The method as recited in claim 16, further comprising:
supplying information about the received request data to a user of the vehicle.

24. The method as recited in claim 16, further comprising:
analyzing an existing field data record in order to identify the at least one missing data record; and
preparing the request data that describe the at least one data record missing in an existing field data record.

25. The method as recited in claim 24, wherein the steps of analyzing and preparing are carried out in a computer system at a distance from the vehicle.

26. The method as recited in claim 16, wherein request data are transmitted to multiple vehicles, and/or sensor data from multiple vehicles are stored in corresponding second memories.

27. The method as recited in claim 16, further comprising:
preparing a training data record for a machine learning system for a vehicle utilizing transmitted data records.

28. A device for a vehicle, configured to:
check whether recorded sensor data in a short-term memory of a vehicle correspond to a data record missing in an existing field data record; and
store the recorded sensor data in a second memory if the check reveals that the recorded sensor data correspond to a missing data record.

29. The device as recited in claim 28, wherein the device is further configured to carry out checking whether the certain recorded sensor data correspond to the missing data record based on the received request data.

30. A vehicle, configured to:
receive, in the vehicle, request data that describe at least one data record missing in an existing field data record;
continuously record sensor data for the vehicle during operation of the vehicle and storing recorded sensor data in a short-term memory;
receive an acknowledge signal indicating that certain of the recorded sensor data corresponds to a missing data record; and
store the certain recorded sensor data in a second memory after receiving the acknowledge signal before the recorded sensor data are deleted from the short-term memory.
